(19) United States
(12) Patent Application Publication
(10) Pub. No.: US 2006/0146784 A1
(43) Pub. Date: Jul. 6, 2006

(54) System and method for monitoring a voice over internet protocol (VoIP) system

(75) Inventors: Roman Karpov, Woburn, MA (US); Lizhong Zhang, Newton, MA (US)

Correspondence Address: FLESHNER & KIM, LLP, P.O. BOX 221200, CHANTILLY, VA, 20153, US

(73) Assignee: iBasis, Inc.

(21) Appl. No.: 11/365,997

(22) Filed: Mar. 2, 2006

Related U.S. Application Data
(63) Continuation-in-part of application No. 10/646,687, filed on Aug. 25, 2003.
Application No. 10/646,687 is a continuation-in-part of application No. 10/298,208, filed on Nov. 18, 2002.
(60) Provisional application No. 60/331,479, filed on Nov. 16, 2001.

(51) Int. Cl. H04M 7/00; H04L 12/28

(52) U.S. Cl. 370/351; 370/352; 379/220.01

(57) ABSTRACT

A system and method for sending long distance telephone calls over the Internet utilizes cost and quality of service data to optimize system performance and to minimize the cost of completing the calls. In addition, the system could utilize a problem identification and analysis system to automatically identify potential problems with system assets. The problem identification and analysis system would compare long term averages of call data and call metrics to short term averages for the same data and metrics. Significant discrepancies between the short term averages and the long term averages would be used to pinpoint potential problems with system assets.

This application is a continuation-in-part of U.S. application Ser. No. 10/646,687, filed Aug. 25, 2003, which is a continuation-in-part of U.S. application Ser. No. 10/298,208, filed Nov. 18, 2002, the disclosure of both of which are hereby incorporated by reference. The application also claims priority to U.S. Provisional Patent Application Ser. No. 60/331,479, filed Nov. 16, 2001, and U.S. Utility application Ser. No. 10/094,671, filed Mar. 7, 2002, the disclosure of both of which are hereby incorporated by reference.

### BACKGROUND OF THE INVENTION

1. Field of the Invention

The invention relates generally to the field of communications, and more specifically to a network configured for Voice over Internet Protocol (VoIP) and/or Facsimile over Internet Protocol (FoIP).

2. Background of the Related Art

Historically, most wired voice communications were carried over the Public Switched Telephone Network (PSTN), which relies on switches to establish a dedicated circuit between a source and a destination to carry an analog or digital voice signal. In the case of a digital voice signal, the digital data is essentially a constant stream of digital data. More recently, Voice over Internet Protocol (VoIP) was developed as a means for enabling speech communication using digital, packet-based, Internet Protocol (IP) networks such as the Internet. A principle advantage of IP is its efficient bandwidth utilization. VoIP may also be advantageous where it is beneficial to carry related voice and data communications over the same channel, to bypass tolls associated with the PSTN, to interface communications originating with Plain Old Telephone Service (POTS) with applications on the Internet, or for other reasons. As discussed in this specification, the problems and solutions related to VoIP may also apply to Facsimile over Internet Protocol (FoIP).

Throughout the description that follows there are references to analog calls over the PSTN. This phrase could refer to analog or digital data streams that carry telephone calls through the PSTN. This is distinguished from VoIP or FoIP format calls, which are formatted as digital data packets.

FIG. 1 is a schematic diagram of a representative architecture in the related art for VoIP communications between originating telephone 100 and destination telephone 145. In alternative embodiments, there may be multiple instances of each feature or component shown in FIG. 1. For example, there may be multiple gateways 125 controlled by a single controller 120. There may also be multiple controllers 120 and multiple PSTN's 115. Hardware and software components for the features shown in FIG. 1 are well-known. For example, controllers 120 and 160 may be Cisco SC2200 nodes, and gateways 125 and 135 may be Cisco AS5300 voice gateways.

To initiate a VoIP session, a user lifts a handset from the hook of originating telephone 100. A dial tone is returned to the originating telephone 100 via Private Branch Exchange (PBX) 110. The user dials a telephone number, which causes the PSTN 115 to switch the call to the originating gateway 125, and additionally communicates a destination for the call to the originating gateway 125. The gateway will determine which destination gateway a call should be sent to using a look-up table resident within the gateway 125, or it may consult the controller 120 for this information.

The gateway then attempts to establish a call with the destination telephone 145 via the VoIP network 130, the destination gateway 135, signaling lines 155 and the PSTN 140. If the destination gateway and PSTN are capable of completing the call, the destination telephone 145 will ring. When a user at the destination telephone 145 lifts a handset and says “hello?” a first analog voice signal is transferred through the PSTN 140 to the destination gateway 135 via lines 155. The destination gateway 135 converts the first analog voice signal originating at the destination telephone 145 into packetized digital data (not shown) and appends a destination header to each data packet. The digital data packets may take different routes through the VoIP network 130 before arriving at the originating gateway 125. The originating gateway 125 assembles the packets in the correct order, converts the digital data to a second analog voice signal (which should be a “hello?” substantially similar to the first analog signal), and forwards the second analog voice signal to the originating telephone 100 via lines 155, PSTN 115 and PBX 110. A user at the originating telephone 100 can speak to a user at the destination telephone 145 in a similar manner. The call is terminated when the handset of either the originating telephone 100 or destination telephone 145 is placed on the hook of the respective telephone. In the operational example described above, the telephone 105 is not used.

In the related art, the controllers 120 and 160 may provide signaling control in the PSTN and a limited means of controlling a gateway at one end of the call. It will be appreciated by those skilled in the art that, in some configurations, all or part of the function of the controllers 120 and 160 as described above may be embedded into the gateways 125 and 135, respectively.

VoIP in the related art presents several problems for a provider of network-based voice communication services. For example, because packets of information follow different routes between source and destination terminals in an IP network, it is difficult for network service providers to track data and bill for network use. In addition, VoIP networks in the related art lack adequate control schemes for routing packets through the Internet based upon the selected carrier service provider, a desired Quality of Service (QoS), cost, and other factors. Moreover, related art controllers do not provide sufficient interfaces between the large variety of signaling systems used in international communications. Other disadvantages related to monitoring and control also exist with present VoIP schemes.

### SUMMARY OF THE INVENTION

An object of the invention is to solve at least one or more of the above problems and/or disadvantages in whole or in part and to provide at least the advantages described hereinafter.

A system and method embodying the invention is used to monitor network call quality. The system and method calculates various average call quality metrics based on data that has been collected over a long period of time. The system then monitors the same call quality metrics over much shorter periods of time, and the short term numbers are compared to the long term averages. If the short term numbers differ from the long term averages by more than a certain amount, the system raises an alarm.

A system and method embodying the invention may also be configured to identify system assets that are causing a problem. For instance, if the system and method find that there are multiple trouble spots, all of which utilize a common system asset, that asset will be identified as potentially defective.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements, and wherein:

FIG. 1 is a schematic diagram of a system architecture providing VoIP communications, according to the background;

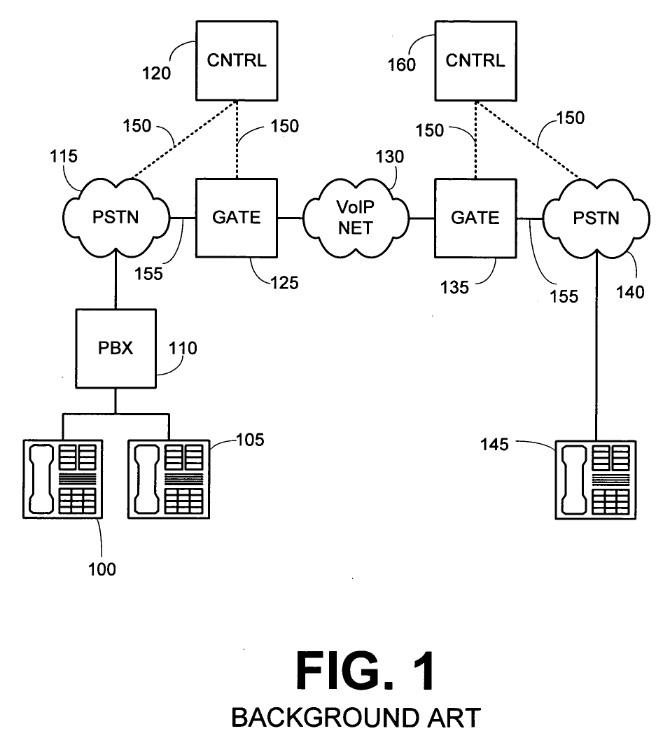

FIG. 2 is a schematic diagram of a system architecture providing VoIP/FoIP communications, according to a preferred embodiment of the invention;

FIG. 3 is a schematic diagram of a system architecture providing improved control for VoIP communications, according to a preferred embodiment of the invention;

FIG. 4 is a flow diagram illustrating a method for routing control, according to a preferred embodiment of the invention;

FIG. 5 is a flow diagram illustrating a method for maintaining a call state, according to a preferred embodiment of the invention;

FIG. 6 is a sequence diagram illustrating a method for communicating between functional nodes of a VoIP network, according to a preferred embodiment of the invention;

FIG. 7 is a flow diagram illustrating a three level routing method, according to a preferred embodiment of the invention;

FIG. 8 is a schematic diagram of a system architecture embodying the invention;

FIG. 9 is a diagram of a matrix illustrating a method for organizing quality of service data for communications paths between gateways;

FIGS. 10A and 10B are flow diagrams of alternate methods of obtaining quality of service data for alternate communications paths;

FIG. 11 is a flow diagram of a method for making routing decisions according to a preferred embodiment of the present invention;

FIG. 12 is a schematic diagram of a system architecture for routing traffic over the Internet, according to a second embodiment of the present invention;

FIG. 13 is a schematic diagram of a problem identification and analysis system embodying the invention;

FIG. 14 is a flow diagram of a method for monitoring network quality according to an exemplary embodiment of the present invention;

FIG. 15 is a flow diagram of a method embodying the invention for comparing short term call quality metrics to long term call quality metrics; and

FIG. 16 is a flow diagram of a method embodying the invention for identifying system assets that may be causing call quality problems.

### DETAILED DESCRIPTION OF PREFERRED EMBODIMENTS

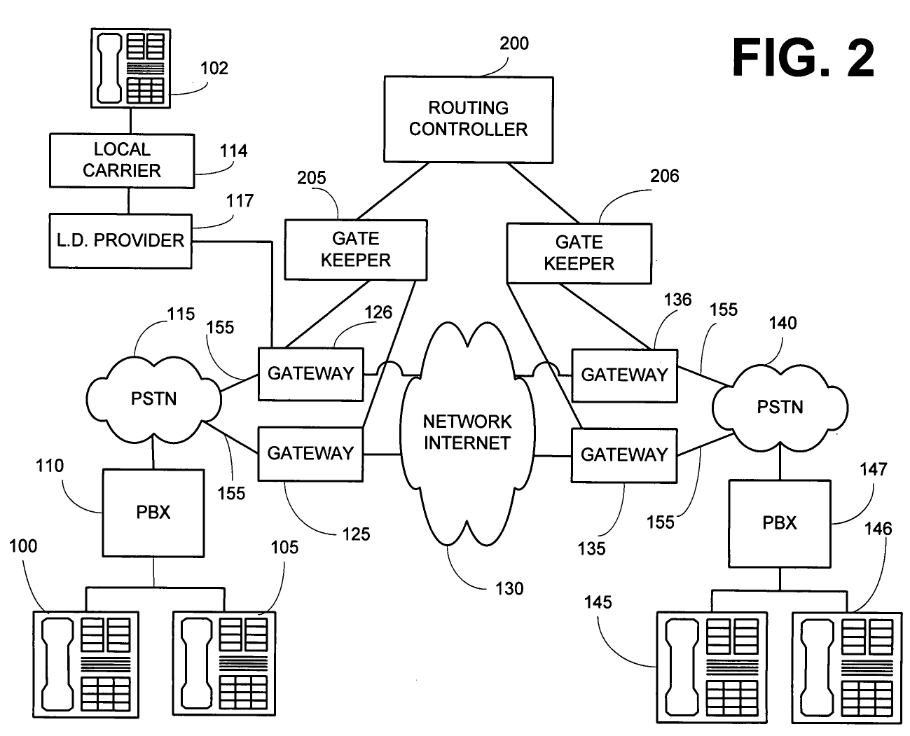

A system embodying the invention is depicted in FIG. 2. The system includes telephones 100/105 connected to a private branch exchange (PBX) 110. The PBX, in turn, is connected to the PSTN 115. In addition, telephones 102 may be coupled to a local carrier 114, which in turn routes long distance calls to one or more long distance service providers 117. Those skilled in the art will recognize that calls could also originate from cellular telephones, computer based telephones, and/or other sources, and that those calls could also be routed through various carriers and service providers. Regardless of where the calls are originating from, they are ultimately forwarded to an originating gateway 125/126.

The originating gateways 125/126 function to convert an analog call into digital packets, which are then sent via the Internet 130 to a destination gateway 135/136. In some instances, the gateways may receive a call that has already been converted into a digital data packet format. In this case, the gateways will function to communicate the received data packets to the proper destination gateways. However, the gateways may modify the received data packets to include certain routing and other formatting information before sending the packets on to the destination gateways.

The gateways 125/126/135/136 are coupled to one or more gatekeepers 205/206. The gatekeepers 205/206 are coupled to a routing controller 200. Routing information used to inform the gateways about where packets should be sent originates at the routing controller.

One of skill in the art will appreciate that although a single routing controller 200 is depicted in FIG. 2, a system embodying the invention could include multiple routing controllers 200. In addition, one routing controller may be actively used by gatekeepers and gateways to provide routing information, while another redundant routing controller may be kept active, but unused, so that the redundant routing controller can step in should the primary routing controller experience a failure. As will also be appreciated by those skilled in the art, it may be advantageous for the primary and redundant routing controllers to be located at different physical locations so that local conditions affecting the primary controller are not likely to also result in failure of the redundant routing controller.

In a preferred embodiment of the invention, as depicted in FIG. 2, the digital computer network 130 used to communicate digital data packets between gateways may be compliant with the H.323 recommendation from the International Telecommunications Union (ITU). Use of H.323 may be advantageous for reasons of interoperability between sending and receiving points, because compliance with H.323 is not necessarily tied to any particular network, platform, or application, because H.323 allows for management of bandwidth, and for other reasons. Thus, in a preferred embodiment, one function of the originating gateways 125 and 126 and the terminating gateways 135 and 136 may be to provide a translation of data between the PSTN's 115/135 and the H.323-based VoIP network 130. Moreover, because H.323 is a framework document, the ITU H.225 protocol may be used for communication and signaling between the gateways 125/126 and 135/136, and the IETF RTP protocol may be used for audio data between the gateways 125/126 and 135/136, and RAS (Registration, Admission, and Status) protocol may be used in communications with the gatekeepers 205/206.

According to the invention, the gatekeeper 205 may perform admission control, address translation, call signaling, call management, or other functions to enable the communication of voice and facsimile traffic over the PSTN networks 115/140 and the VoIP network 130. The ability to provide signaling for networks using Signaling System No. 7 (SS7) and other signaling types may be advantageous over network schemes that rely on gateways with significantly less capability. For example, related art gateways not linked to the gatekeepers of the present invention may only provide signaling for Multi-Frequency (MF), Integrated Services Digital Network (ISDN), or Dual Tone Multi-Frequency (DTMF).

According to a preferred embodiment of the present invention, the gatekeeper 205 may further provide an interface between different gateways, and the routing controller 200. The gatekeeper 205 may transmit routing requests to the routing controller 200, receive an optimized route from the routing controller 200, and execute the route accordingly.

Persons skilled in the art of communications will recognize that gatekeepers may also communicate with other gatekeepers to manage calls outside of the originating gatekeeper's area of control. Additionally, it may be advantageous to have multiple gatekeepers linking a particular gateway with a particular routing controller so that the gatekeepers may be used as alternates, allowing calls to continue to be placed to all available gateways in the event of failure of a single gatekeeper. Moreover, although the gatekeeping function may be logically separated from the gateway function, embodiments where the gatekeeping and gateway functions are combined onto a common physical host are also within the scope of the invention.

In a system embodying the present invention, as shown in FIG. 2, a routing controller 200 is logically coupled to gateways 125/126 and 135/136 through gatekeepers 205/206. The routing controller 200 contains features not included in the prior art signaling controllers 120 and 160 of the prior art systems described above, as will be described below. Routing controller 200 and gatekeepers 205/206 may be hosted on one or more network-based servers which may be or include, for instance, a workstation running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™, Java Virtual Machine or other operating system or platform. Detailed descriptions of the functional portions of a typical routing controller embodying the invention are provided below.

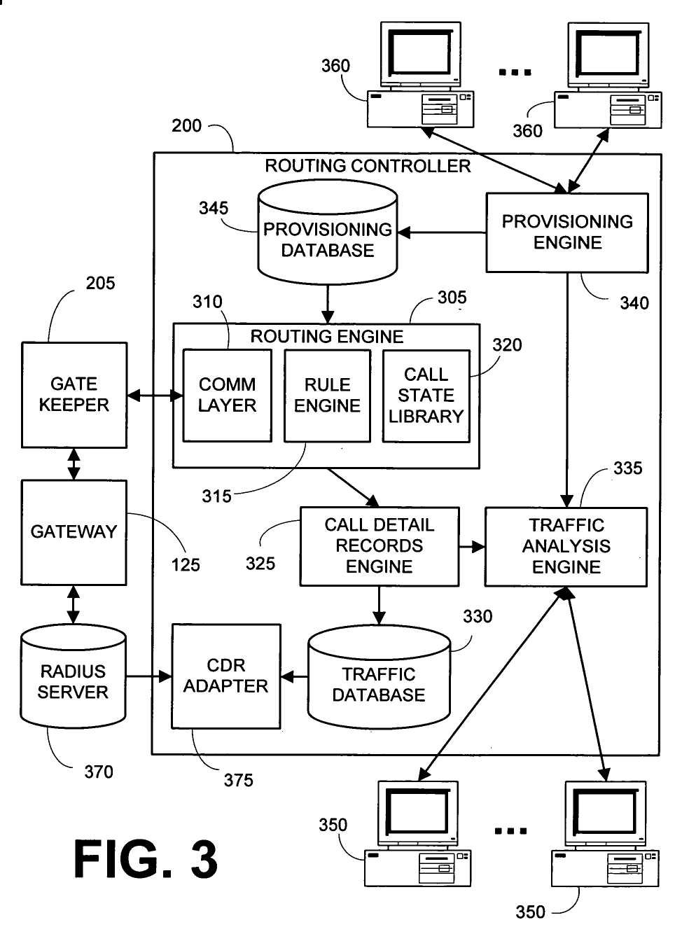

As indicated in FIG. 3, a routing controller 200 may include a routing engine 305, a Call Detail Record (CDR) engine 325, a traffic database 330, a traffic analysis engine 335, a provisioning engine 340, and a provisioning database 345. The routing engine 305, CDR engine 325, traffic analysis engine 335, and provisioning engine 340 may exist as independent processes and may communicate to each other through standard interprocess communication mechanisms. They might also exist on independent hosts and communicate via standard network communications mechanisms.

In alternative embodiments, the routing engine 305, Call Detail Record (CDR) engine 325, traffic database 330, traffic analysis engine 335, provisioning engine 340, or provisioning database 345 may be duplicated to provide redundancy. For instance, two CDR engines 325 may function in a master-slave relationship to manage the generation of billing data.

The routing engine 305 may include a communications layer 310 to facilitate an interface between the routing engine 305 and the gatekeepers 205/206. Upon receipt of a routing request from a gatekeeper, the routing engine 305 may determine the best routes for VoIP traffic based upon one or more predetermined attributes such as the selected carrier service provider, time of day, a desired Quality of Service (QoS), cost, or other factors. The routing information generated by the routing engine 305 could include a destination gateway address, and/or a preferred Internet Service Provider to use to place the call traffic into the Internet. Moreover, in determining the best route, the rule engine 315 may apply one or more exclusionary rules to candidate routes, based upon known bad routes, provisioning data from provisioning database 345, or other data.

The routing engine 305 may receive more than one request to route a single call. For example, when a first routing attempt was declined by the terminating gateway, or otherwise failed to result in a connection, or where a previous routing attempt resulted in a disconnect other than a hang-up by the originator or recipient, then the routing engine may receive a second request to route the same call. To provide redundancy, the routing engine 305 may generate alternative routes to a particular far-end destination. In a preferred embodiment of the invention, when the routing engine receives a routing request, the routing engine will return both preferred routing information, and alternative routing information. In this instance, information for at least one next-best route will be immediately available in the event of failure of the preferred route. In an alternative embodiment, routing engine 305 may determine a next-best route only after the preferred route has failed. An advantage of the latter approach is that routing engine 305 may be able to better determine the next-best route with the benefit of information concerning the most recent failure of the preferred route.

To facilitate alternative routing, and for other reasons, the routing engine 305 may maintain the state of each VoIP call in a call state library 320. For example, routing engine 305 may store the state of a call as “set up,” “connected,” “disconnected,” or some other state.

Routing engine 305 may further format information about a VoIP call such as the originator, recipient, date, time, duration, incoming trunk group, outgoing trunk group, call states, or other information, into a Call Detail Record (CDR). Including the incoming and outgoing trunk group information in a CDR may be advantageous for billing purposes over merely including IP addresses, since IP addresses may change or be hidden, making it difficult to identify owners of far-end network resources. Routing engine 305 may store CDR's in a call state library 320, and may send CDR's to the CDR engine 325 in real time, at the termination of a call, or at other times.

The CDR engine 325 may store CDR's to a traffic database 330. To facilitate storage, the CDR engine 325 may format CDR's as flat files, although other formats may also be used. The CDR's stored in the traffic database 330 may be used to generate bills for network services. The CDR engine 325 may also send CDR's to the traffic analysis engine 335.

Data necessary for the billing of network services may also be stored in a Remote Authentication Dial-In User Service (RADIUS) server 370. In fact, in some embodiments, the data stored in the RADIUS server may be the primary source of billing information. The RADIUS server 370 may also directly communicate with a gateway 125 to receive and store data such as incoming trunk group, call duration, and IP addresses of near-end and far-end destinations. The CDR adapter 375 may read data from both the traffic database 330 and the RADIUS server 370 to create a final CDR. The merged data supports customer billing, advantageously including information which may not be available from RADIUS server 370 alone, or the traffic database 330 alone.

The traffic analysis engine 335 may collect CDR's, and may automatically perform traffic analysis in real time, near real time, or after a predetermined delay. In addition, traffic analysis engine 335 may be used to perform post-traffic analysis upon user inquiry. Automatic or user-prompted analysis may be performed with reference to a predetermined time period, a specified outgoing trunk group, calls that exceed a specified duration, or according to any other variable(s) included in the CDR's.

The provisioning engine 340 may perform tasks necessary to route particular calls over the Internet. For example, the provisioning engine 340 may establish or modify client account information, authorize a long distance call, verify credit, assign phone numbers where the destination resides on a PSTN network, identify available carrier trunk groups, generate routing tables, or perform other tasks. In one embodiment of the invention, provisioning may be performed automatically. In another embodiment, provisioning may be performed with user input. Hybrid provisioning, that is, a combination of automated and manual provisioning, may also be performed. The provisioning engine 340 may further cause provisioning data to be stored in a provisioning database 345.

Client workstations 350 and 360 may be coupled to routing controller 200 to provide a user interface. As depicted in FIG. 3, the client(s) 350 may interface to the traffic analysis engine 335 to allow a user to monitor network traffic. The client(s) 360 may interface to the provisioning engine 340 to allow a user to view or edit provisioning parameters. In alternative embodiments, a client may be adapted to interface to both the traffic analysis engine 335 and provisioning engine 340, or to interface with other features of routing controller 200.

In a system embodying the invention, as shown in FIG. 2, the gateways 125/126 would first receive a request to set up a telephone call from the PSTN, or from a Long Distance Provider 117, or from some other source. The request for setting up the telephone call would typically include the destination telephone number. In order to determine which destination gateway should receive the packets, the gateway would consult the gatekeeper 205.

The gatekeeper 205, in turn may consult the routing controller 200 to determine the most appropriate destination gateway. In some situations, the gatekeeper may already have the relevant routing information. In any event, the gatekeeper would forward the routing information to the originating gateway 125/126, and the originating gateway would then send the appropriate packets to the appropriate destination gateway. As mentioned previously, the routing information provided by the gatekeeper may include just a preferred destination gateway, or it may include both the preferred destination gateway information, and information on one or more next-best destination gateways. The routing information may also include a preferred route or path onto the Internet, and one or more next-best route. The routing information may further include information about a preferred Internet Service Provider.

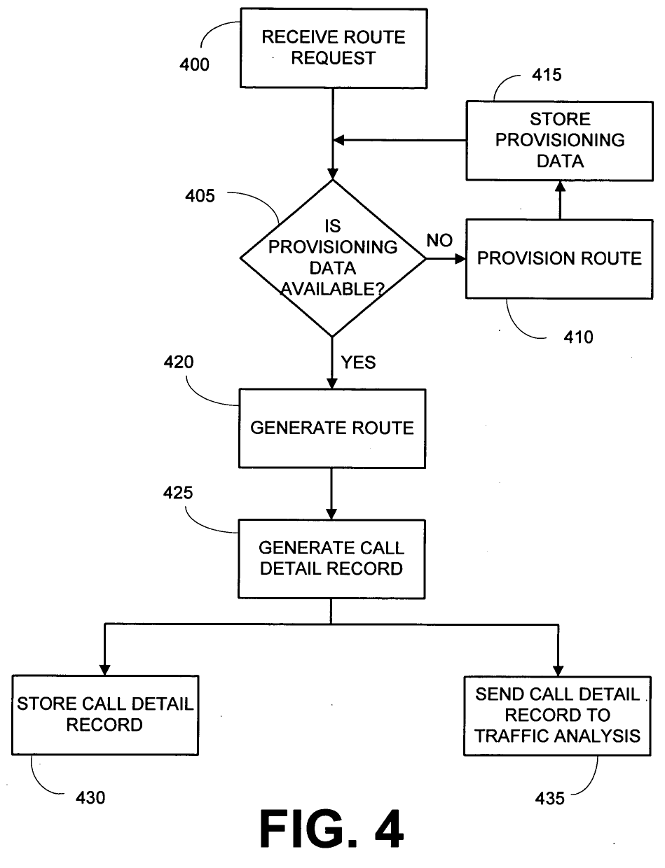

FIG. 4 is a flow chart illustrating a method embodying the invention for using the routing controller 200. In step 400, the routing controller 200 receives a routing request from either a gatekeeper, or a gateway. In step 405, a decision is made as to whether provisioning data is available to route the call. If the provisioning data is not available, the process advances to step 410 to provision the route, then to step 415 for storing the provisioning data before returning to decision step 405.

If, on the other hand, if it is determined in step 405 that provisioning data is available, then the process continues to step 420 for generating a route. In a preferred embodiment of the invention, step 420 may result in the generation of information for both a preferred route, and one or more alternative routes. The alternative routes may further be ranked from best to worst.

The routing information for a call could be simply information identifying the destination gateway to which a call should be routed. In other instances, the routing information could include information identify the best Internet Service Provider to use to place the call traffic onto the Internet. In addition, the routing controller may know that attempting to send data packets directly from the originating gateway to the destination gateway is likely to result in a failed call, or poor call quality due to existing conditions on the Internet. In these instances, the routing information may include information that allows the data packets to first be routed from the originating gateway to one or more interim gateways, and then from the interim gateways to the ultimate destination gateway. The interim gateways would simply receive the data packets and immediately forward the data packets on to the ultimate destination gateway.

Step 420 may also include updating the call state library, for example with a call state of “set up” once the route has been generated. Next, a CDR may be generated in step 425. Once a CDR is available, the CDR may be stored in step 430 and sent to the traffic analysis engine in step 435. In one embodiment, steps 430 and 435 may be performed in parallel, as shown in FIG. 4. In alternative embodiments, steps 430 and 435 may be performed sequentially. In yet other embodiments, only step 430 or only 435 may be performed.

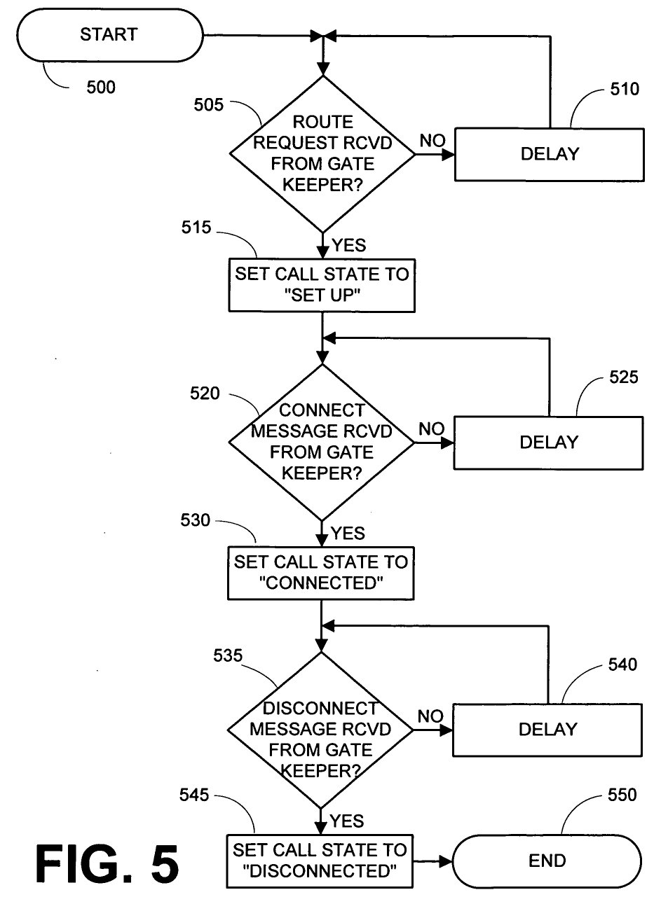

FIG. 5 is a flow diagram illustrating a method for maintaining a call state, which may be performed by routing engine 305. After starting in step 500, the process may determine in step 505 whether a route request has been received from a gatekeeper or other source. If a routing request has not been received, the process may advance to a delay step 510 before returning to decision step 505. If, however, it is determined in step 505 that a route request has been received, then a call state may be set to “set up” in step 515.

The process of FIG. 5 may then determine in step 520 whether a connect message has been received from a gatekeeper or other source. If a connect message has not been received, the process may advance to delay step 525 before returning to decision step 520. If, however, it is determined in step 520 that a connect message has been received, then a call state may be set to “connected” in step 530.

The process of FIG. 5 may then determine in step 535 whether a disconnect message has been received from a gate keeper or other source. If a disconnect message has not been received, the process may advance to delay step 540 before returning to decision step 535. If, however, it is determined in step 535 that a disconnect message has been received, then a call state may be set to “disconnected” in step 545 before the process ends in step 550.

The process depicted in FIG. 5 will operate to keep the call state for all existing calls up to date to within predetermined delay limits. In alternative embodiments of the invention, the call state monitoring process can monitor for other call states such as “hang-up,” “busy,” or other call states not indicated above. Moreover, monitoring for other call states may be instead of, or in addition to, those discussed above. Further, in one embodiment, monitoring could be performed in parallel, instead of the serial method illustrated in FIG. 5.

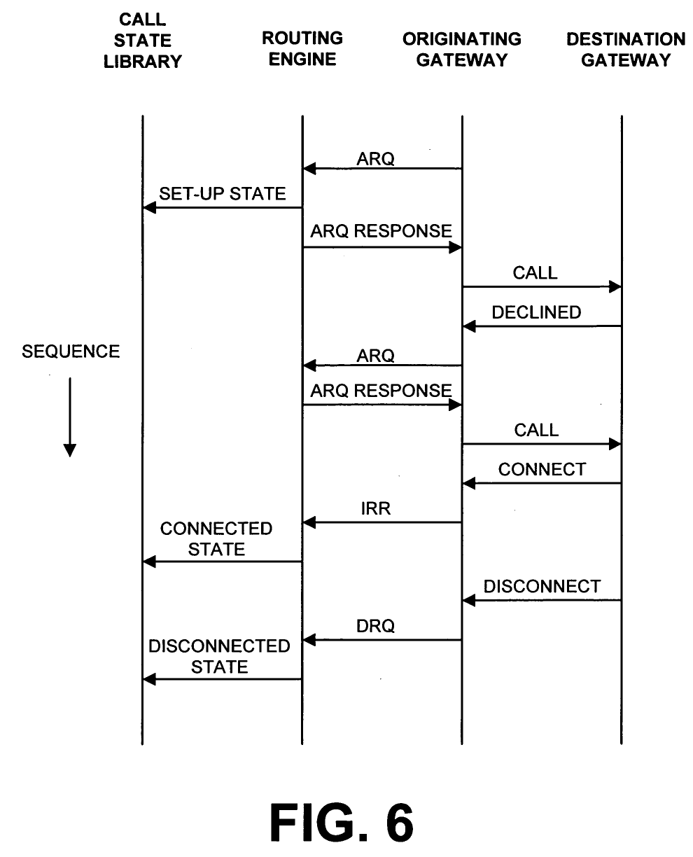

FIG. 6 discloses a sequence of messages between an originating gateway, a routing engine, a call state library, and a destination gateway, according to a preferred embodiment of the invention. In operation of the network, the originating gateway may send a first request for routing information, in the form of a first Admission Request (ARQ) message, to a routing engine within a routing controller. The request would probably be passed on through a gatekeeper logically positioned between the gateway and the routing engine in the routing controller.

Upon receipt of the routing request, the routing engine may store a set-up state in call state library. The routing engine may then determine a best route based upon one or more predetermined attributes such as the selected carrier service provider, a desired Quality of Service (QoS), cost, or other factors. The routing engine may then send information pertaining to the best route to the originating gateway, possibly via a gatekeeper, as a first ARQ response message. The gateway would then initiate a first call to a destination gateway using the information contained within the response message. As shown in FIG. 6, the destination gateway may return a decline message to the originating gateway.

When the originating gateway receives a decline message, the gateway may send a second request for routing information, in the form of a second ARQ message, to routing engine. Routing engine may recognize the call as being in a set up state, and may determine a next best route for completion of the call. Routing engine may then send a second ARQ response message to the originating gateway. The originating gateway may then send a second call message to the same or a newly selected destination gateway using the next best route. In response to the second call message, the destination gateway may return a connect message to the originating gateway.

The routing engine may use a conference ID feature of the H.323 protocol, which is unique to every call, in order to keep track of successive routing attempts. Thus, upon receiving a first ARQ for a particular call, routing engine may respond with a best route; upon receiving a second ARQ associated with the same call, routing engine may respond with the second best route. If the second call over the next best route does not result in a connection, the originating gateway may send a third ARQ message to routing engine, and so on, until an ARQ response message from routing engine enables a call to be established between the originating gateway and a destination gateway capable of completing the call to the called party.

In alternative embodiments of the invention, the initial ARQ response from the routing engine to the originating gateway may include information about the best route, and one or more next-best routes. In this instance, when a call is declined by one terminating gateway, the originating gateway can simply attempt to route the call using the next-best route without the need to send additional queries to the routing engine.

Once the originating gateway receives a connect message from a destination gateway, the originating gateway may send an Information Request Response (IRR) message to the routing engine to indicate the connect. In response, the routing engine may store a connected state message to the call state library.

After a call is connected, a call may become disconnected. A disconnect may occur because a party has hung up, because of a failure of a network resource, or for other reasons. In this instance, destination gateway may send a disconnect message to the originating gateway. In response, originating gateway may send a Disengage Request (DRQ) message to the routing engine. The routing engine may then update the call state by storing a disconnected state status in the call state library.

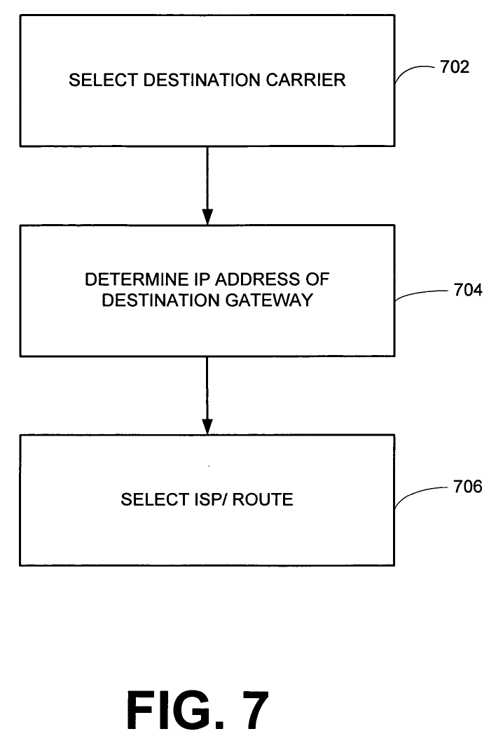

FIG. 7 is a flow diagram illustrating a method, according to a preferred embodiment of the invention, for generating routing information in response to a routing request. As shown in FIG. 7, when a routing controller (or a gatekeeper) receives a routing request from a gateway, the method first involves selecting a destination carrier that is capable of completing the call to the destination telephone in step 702. In some instances, there may be only one destination carrier capable of completing the call to the destination telephone. In other instances, multiple destination carriers may be capable of completing the call. In those instances where multiple carriers are capable of completing the call, it is necessary to initially select one destination carrier. If the call is completed on the first attempt, that carrier will be used. If the first attempt to complete the call fails, the same or a different carrier may ultimately be used to complete the call.

Where there are multiple destination carriers capable of completing the call, the selection of a particular destination carrier may be based on one or more considerations including the cost of completing the call through the destination carriers, the quality of service offered by the destination carriers, or other considerations. The destination carrier may be selected according to other business rules including, for example, an agreed upon volume or percentage of traffic to be completed through a carrier in a geographic region. For instance, there may be an agreement between the system operator and the destination carrier that calls for the system operator to make minimum daily/monthly/yearly payments to a destination carrier in exchange for the destination carrier providing a predetermined number of minutes of service. In those circumstances, the system operator would want to make sure that the destination carrier is used to place calls for at least the predetermined number of minutes each day/month/year before routing calls to other destination carriers to ensure that the system operator derives the maximum amount of service from the destination carrier in exchange for the minimum guaranteed payment. Business rules taking onto account these and other similar types of considerations could then be used to determine which destination carrier to use.

Once the destination carrier has been selected, the method would include identifying an IP address of a destination gateway connected to the destination carrier and capable of passing the call on to the destination carrier. The destination gateway could be operated by the system operator, or by the destination carrier, or by a third party. Typically, a table would be consulted to determine which destination gateways correspond to which destination carriers and geographic locations.

Often there may be multiple destination gateways capable of completing a call to a particular destination carrier. In this situation, the step of determining the IP address could include determining multiple destination IP addresses, each of which correspond to destination gateways capable of completing the call to the destination carrier. Also, the IP address information may be ranked in a particular order in recognition that some destination gateways may offer more consistent or superior IP quality. Also, if two or more destination gateways capable of completing a call to a destination carrier are operated by different parties, there may be cost considerations that are also used to rank the IP address information. Of course, combinations of these and other considerations could also be used to select particular destination gateways, and to thus determine the IP address(s) to which data packets should be sent.

In some embodiments of the invention, determining the IP address(s) of the terminating gateway(s) may be the end of the process. This would mean that the system operator does not care which Internet Service Provider (ISP) or which route is used to place data traffic onto the Internet. In other instances, the method would include an additional step, step 806, in which the route onto the Internet and/or the ISP would then be selected. The selection of a particular ISP may be based on a quality of service history, the cost of carrying the data, or various other considerations. The quality of service history may take into account packet loss, latency and other IP based considerations. Also, one ISP may be judged superior at certain times of the day/week, while another ISP may be better at other times. As will be described in more detail below, the system has means for determining the quality of service that exists for various routes onto the Internet. This information would be consulted to determine which route/ISP should be used to place call data onto the Internet. Further, as mentioned above, in some instances, the routing information may specify that the call data be sent from the originating gateway to an interim gateway, and then from the interim gateway to the destination gateway. This could occur, for example, when the system knows that data packets placed onto the Internet at the originating gateway and addressed directly to the destination gateway are likely to experience unacceptable delays or packet loss.

In some instances, the quality of service can be the overriding consideration. In other instances, the cost may be the primary consideration. These factors could vary client to client, and call to call for the same client.

For example, the system may be capable of differentiating between customers requiring different call quality levels. Similarly, even for calls from a single customer, the system may be capable of differentiating between some calls that require high call quality, such as facsimile transmissions, and other calls that do not require a high call quality, such as normal voice communications. The needs and desires of customers could be determined by noting where the call originates, or by other means. When the system determines that high call quality is required, the system may eliminate some destination carriers, destination gateways, and ISPs/routes from consideration because they do not provide a sufficiently high call quality. Thus, the system may make routing decisions based on different minimum thresholds that reflect different customer needs.

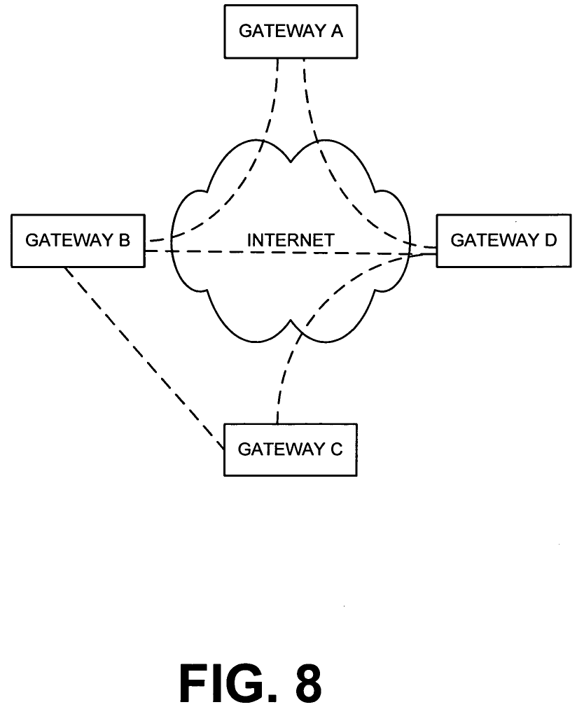

FIG. 8 shows a conceptual diagram of four gateways with access to the Internet. Gateway A can reach Gateways B and C via the Internet. Gateway C can reach Gateway D via the Internet, and Gateway B via an external connection. Due to Internet conditions, it will often be the case that certain Gateways, while having access to the Internet, cannot reliably send data packets to other gateways connected to the Internet. Thus, FIG. 8 shows that Gateway C cannot reach Gateways B or A through the Internet. This could be due to inordinately long delays in sending data packets from Gateway C to Gateways A and B, or for other reasons.

The gateways illustrated in FIG. 8 could be gateways controlled by the system operator. Alternatively, some of the gateways could be maintained by a destination carrier, or a third party. As a result, the gateways may or may not be connected to a routing controller through a gatekeeper, as illustrated in FIG. 2. In addition, some gateways may only be capable of receiving data traffic and passing it off to a local or national carrier, while other gateways will be capable of both receiving and originating traffic.

Some conclusions logically flow from the architecture illustrated in FIG. 8. For instance, Gateway B can send data traffic directly to Gateway D through the Internet, or Gateway B could choose to send data to Gateway D by first sending the traffic to Gateway A, and then having Gateway A forward the traffic to Gateway D. In addition, Gateway B could send the traffic to Gateway C via some type of direct connection, and then have Gateway C forward the data on to Gateway D via the Internet.

The decision about how to get data traffic from one gateway to another depends, in part, on the quality of service that exists between the gateways. The methods embodying the invention that are described below explain how one can measure the quality of service between gateways, and then how the quality measurements can be used to make routing decisions.

As is well known in the art, a first gateway can “ping” a second gateway. A “ping” is a packet or stream of packets sent to a specified IP address in expectation of a reply. A ping is normally used to measure network performance between the first gateway and the second gateway. For example, pinging may indicate reliability in terms of a number of packets which have been dropped, duplicated, or re-ordered in response to a pinging sequence. In addition, a round trip time, average round trip time, or other round trip time statistics can provide a measure of system latency.

In some embodiments of the invention, the quality of service measurements may be based on an analysis of the round trip of a ping. In other embodiments, a stream of data packets sent from a first gateway to a second gateway could simply be analyzed at the second gateway. For instance, numbered and time-stamped data packets could be sent to the second gateway, and the second gateway could determine system latency and whether packets were dropped or reordered during transit. This information could then be forwarded to the routing controller so that the information about traffic conditions between the first and second gateways is made available to the first gateway.

A system as illustrated in FIG. 8 can use the data collected through pings to compare the quality and speed of a communication passing directly between a first gateway and a second gateway to the quality and speed of communications that go between the first and second gateways via a third or intermediate gateway. For instance, using the system illustrated in FIG. 8 as an example, the routing controller could hold information about traffic conditions directly between Gateway B and Gateway D, traffic conditions between Gateway B and Gateway A, and traffic conditions between Gateway A and Gateway D. If Gateway B wants to send data packets to Gateway D, the routing controller could compare the latency of the route directly from Gateway B to Gateway D to the combined latency of a route that includes communications from Gateway B to Gateway A and from Gateway A to Gateway D. Due to local traffic conditions, the latency of the path that uses Gateway A as an interim Gateway might still be less than the latency of the direct path from Gateway B to Gateway D, which would make this route superior.

In methods embodying the invention, each gateway capable of directly accessing another gateway via the Internet may periodically ping each of the other gateways. The information collected from the pings is then gathered and analyzed to determine one or more quality of service ratings for the connection between each of the gateways. The quality of service ratings can then be organized into tables, and the tables can be used to predict whether a particular call path is likely to provide a given minimum quality of service.

To reduce the amount of network traffic and the volume of testing, only one gateway within a group of co-located gateways may be designated as a proxy tester for all gateways within the co-located group. In addition, instead of pinging a far-end gateway, one might ping other Internet devices that are physically close to the far-end gateway. These steps save network bandwidth by reducing the required volume of testing. Also, the testing can be delegated to lower cost testing devices, rather than expensive gateways.

A quality of service measure would typically be calculated using the raw data acquired through the pinging process. As is well known to those of skill in the art, there are many different types of data that can be derived from the pinging itself, and there is an almost infinite variety of ways to combine this data to calculate different quality of service measures.

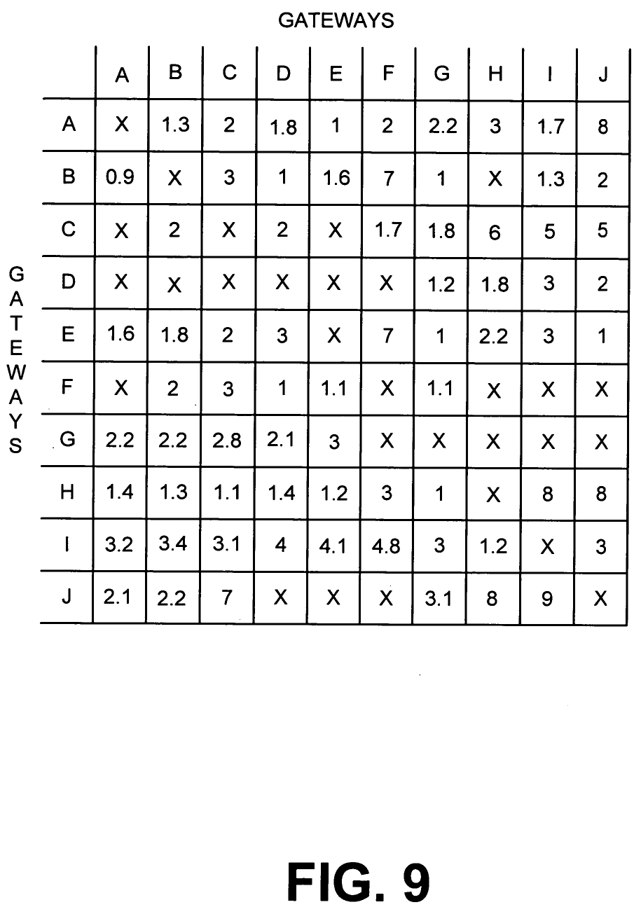

FIG. 9 is a diagram of a matrix of quality of service data that indicates the quality of service measured between 10 different gateways, gateways A-J. This table is prepared by having each of the gateways ping each of the other gateways. The data collected at a first gateway is then collected and used to calculate a quality of rating between the first gateway and each of the other gateways. A similar process of collection and calculation occurs for each of the other gateways in the system. The calculated quality of service values are then inserted into the matrix shown in FIG. 9. For instance, the quality measure value at the intersection of row A and column D is 1.8. Thus, the value of 1.8 represents the quality of service for communications between Gateways A and D. When an X appears in the matrix, it means that no communications between the row and column gateways was possible the last time the pings were collected.

Although only a single value is shown in the matrix illustrated in FIG. 9, multiple quality of service values could be calculated for communications between the various gateways. In other words, multiple values might be stored at each intersection point in the matrix. For instance, pings could be used to calculate the packet loss (PL), latency (LA), and a quality of service value (Q) which is calculated from the collected pinging data. In this instance, each intersection in the matrix would have an entry of “PL, LA, Q”. Other combinations of data could also be used in a method and matrix embodying the invention.

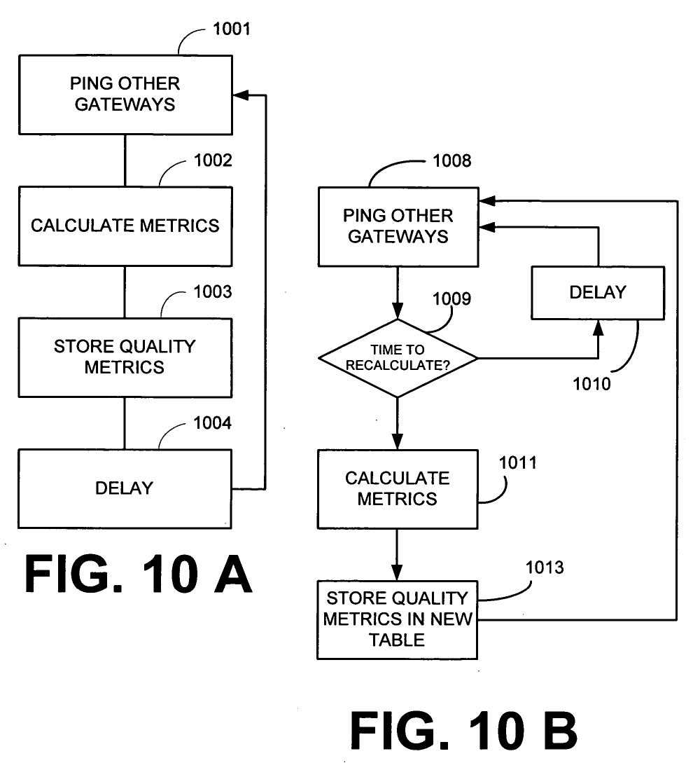

The pinging, data collection and calculation of the values shown in the matrix could be done in many different ways. Two alternative methods are illustrated in FIGS. 10A and 10B.

In the method shown in FIG. 10A, pinging occurs in step 1001. As discussed above, this means that each gateway pings the other gateways and the results are recorded. In step 1002, the data collected during the pinging step is analyzed and used to calculate various quality measures. In step 1003, the quality metrics are stored into the matrix. The matrix can then be used, as discussed below, to make routing decisions. In step 1004, the method waits for a predetermined delay period to elapse. After the delay period has elapsed, the method returns to step 1001, and the process repeats.

It is necessary to insert a delay into the method to avoid excessive pinging from occurring. The traffic generated by the pinging process takes up bandwidth that could otherwise be used to carry actual data traffic. Thus, it is necessary to strike a balance between conducting the pinging often enough to obtain accurate information and freeing up the system for actual data traffic. In addition, the bandwidth used by testing can also be managed by controlling the number of pings sent per test. Thus, the consumption of bandwidth is also balanced against the ability to measure packet loss.

The alternate method shown in FIG. 10B begins at step 1008 when the pinging process is conducted. Then, in step 1009, the system determines whether it is time to re-calculate all the quality of service metrics. This presupposes that the matrix will only be updated at specific intervals, rather than each time a pinging process is conducted. If it is not yet time to update the matrix, the method proceeds to step 1010, where a delay period is allowed to elapse. This delay is inserted for the same reasons discussed above. Once the delay period has elapsed, the method returns to step 1008 where the pinging process is repeated.

If the result of step 1009 indicates that it is time to recalculate the quality metrics, the method proceeds to step 1011, where the calculations are performed. The calculated quality metrics are then stored in the matrix in step 1013, and the method returns to step 1008. In this method, the matrix is not updated as frequently, and there is not as high a demand for performing the calculations. This can conserve valuable computer resources. In addition, with a method as illustrated in FIG. 10B, there is data from multiple pings between each of the gateways for use in making the calculations, which can be desirable depending on the calculations being performed. In some embodiments of the invention, once the Quality Metrics have been updated, the system may wait for a delay period to elapse before returning to step 1008 to restart the pinging process. Furthermore, the system may conduct a certain amount of pinging, then wait before calculating the metrics. In other words, the pinging and calculating steps may be on completely different schedules.

In either of the methods described above, the data used to calculate the quality metrics could include only the data recorded since the last calculations, or additional data recorded before the last set of quality metrics were calculated. For instance, pinging could occur every five minutes, and the quality metrics could be calculated every five minutes, but each set of calculations could use data recorded over the last hour.

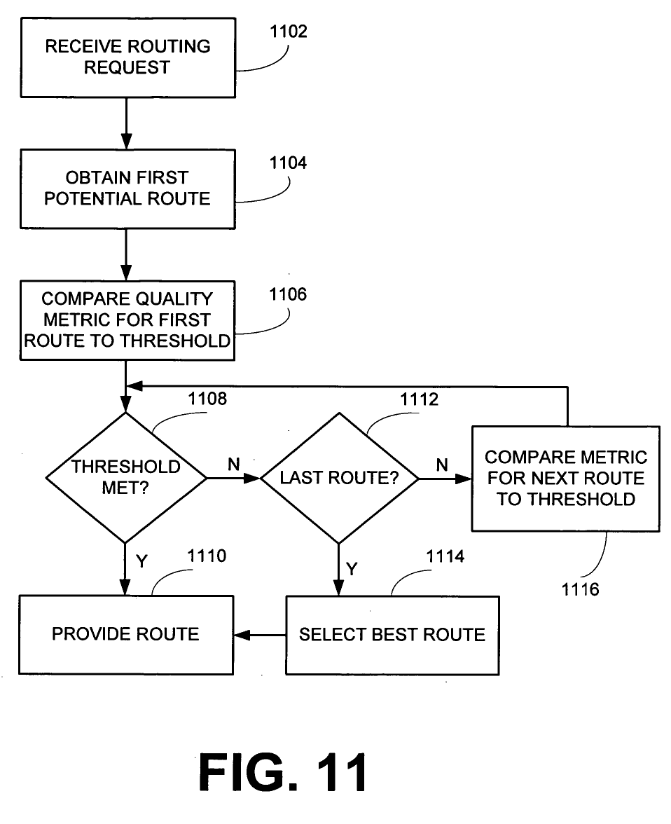

FIG. 11 illustrates a method embodying the invention for selecting and providing routing information to a gateway making a routing request. This method would typically be performed by the gatekeeper connected to a gateway, or by the routing controller.

In step 1102, a routing request would be received. In step 1104, the system would obtain a first potential route. This step could involve all of the considerations discussed above relating to the selection of a destination carrier and/or destination gateway and/or an ISP or route between the originating gateway and the destination gateway.

Once the first potential route is determined, in step 1106 the system would look up the quality metrics associated with communications between the originating and destination gateways. This would involve consulting the quality matrix discussed above. One or more quality values in the matrix relating to the first proposed route would be compared to a threshold value in step 1108. If the quality for the first route satisfies the threshold, the method would proceed to step 1110, and the route would be provided to the requesting gateway as a potential route for completion of a call.

If the result of comparison step 1108 indicates that the quality of service metrics for the first route do not satisfy the threshold, then in step 1112 the system would determine if this is the last available route for completing the call. If so, the method would proceed to step 1114, where the best of the available routes would be determined by comparing the quality metrics for each of the routes considered thus far. Then the method would proceed to step 1110, where the best available route would be provided to the requesting gateway.

If the result of step 1112 indicates that there are alternative routes available, the method would proceed to step 1116, where the quality metrics for the next available route would be compared to the threshold value. The method would then proceed to step 1108 to determine if the threshold is satisfied.

A method like the one illustrated in FIG. 11 could be used to identify multiple potential routes for completing a call that all satisfy a basic threshold level of service. The quality metrics associated with each route could then be used to rank the potential routes. Alternatively, the cost associated with each route could be used to rank all routes satisfying the minimum quality of service threshold. In still other alternative embodiments, a combination of cost and quality could be used to rank the potential routes. As explained above, the ranked list of potential routes could then be provided to the requesting gateway.

As also explained above, in providing a route to a gateway, the routing controller may specify either a direct route between the gateways, or a route that uses an interim gateway to relay data packets between an originating and destination gateway. Thus, the step of identifying a potential route in step 1104 could include identifying both direct routes, and indirect routes that pass through one or more interim gateways. When interim gateways are used, the quality metrics for the path between the originating gateway and the interim gateway and the path between the interim gateway and the destination gateway would all have to be considered and somehow combined in the comparison step.

In a system embodying the invention, as shown in FIG. 2, multiple different gateways are all routing calls using routing information provided by the routing controller 200. The routing information stored in the routing controller includes tables that are developed using the methods described above. The routing table indicates the best available routes between any two gateways that are connected to the system. Even when there are multiple routing controllers that are a part of the system, all routing controllers normally have the same routing table information. This means that each time a gateway asks for a route to a destination telephone number, the routing information returned to the gateway will be the same, regardless of which gateway made the routing request. As will be explained below, in prior art systems, the fact that all gateways receive the same routing information can lead to unnecessary signaling and looping of call setup requests.

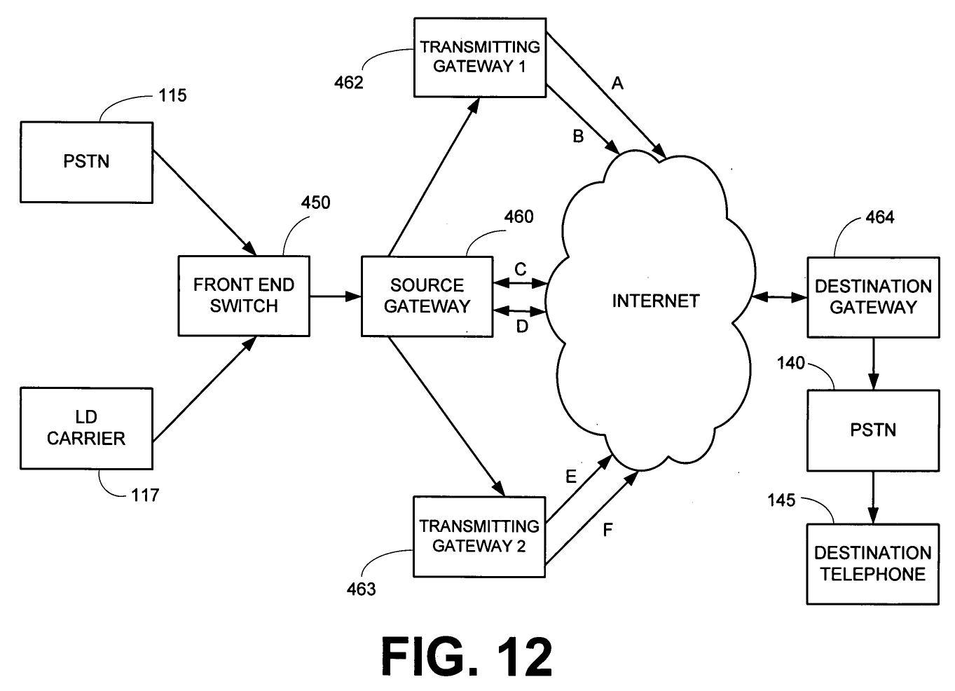

FIG. 12 shows the basic architecture of a system embodying the invention. As shown therein, the PSTN 115 and/or a long distance carrier 117 both deliver calls to a front end switch 450 of the system. The calls arrive at the front end switch 450 as a call set-up request to complete a call to the destination telephone 145. The front end switch 450 or the Source Gateway 460 can then consult a route controller, wherein the route controller determines the most optimal route and a gateway associated with the most optimal route, which can convert the call into digital data packets and place the packets on to the Internet properly addressed to the designation gateway 464. Additionally, a destination gateway may be chosen from a plurality of destination gateways depending on such criteria as, but not limited to, compatibility, dependability, and efficiency. The route controller ranks the routes from the most optimal to least optimal.

Once a route is identified, the call request would be formatted as digital data packets that include header data with routing information. For example the header can include information such as the originating gateway associated with the most optimal route, the destination gateway, and the destination telephone number. The Source Gateway 460 then attempts to complete the call to the destination gateway.

Each of the individual gateways can place data traffic onto the Internet using one or more routes or access points. In the system illustrated in FIG. 12, Source Gateway 460 can place traffic onto the Internet using route C or D. The First Transmitting Gateway 462 can place traffic on the Internet using routes A and B. The Second Transmitting Gateway 463 can place traffic onto the Internet using routes E and F. At any given point in time, one or more of these routes can become inoperative or simply degraded in performance to the point that making a voice call through the route results in poor call quality.

In prior art systems, when the front end switch 450 receives a call request for a call intended for the destination telephone 145 from either the PSTN 115 or the long distance carrier 117, the front end switch would forward the call to one of the gateways so that the call setup procedures could be carried out. For purposes of explanation, assume that the call request is forwarded to Source Gateway 460. The gateway would then make a routing request to the routing controller for information about the address of the destination gateway, and the most preferable route to use to get the data onto the Internet. Again, for purposes of explanation, assume that the routing controller responds with the address of the destination gateway 464, and with the information that the best routes, in preferred order, are routes C, then A, and then E.

With this information, Source Gateway 460 would first try to set the call up to go to the destination gateway 464 via route C. Assume that for whatever reason, route C fails. Source Gateway would then consult the routing information again and determine that the next best route is route A. Thus, Source Gateway would forward the call on to the First Transmitting Gateway 462, which is capable of using route A.

When the First Transmitting Gateway 462 receives the call request, it too will consult the routing controller for routing information. The same information will be returned to the First Transmitting Gateway 462, indicating that the preferred routes are C, then A, then E. With this information, the First Transmitting Gateway 462 believes that route C is the best route, so the First Transmitting Gateway 462 would bounce the call request back to Source Gateway 460, so that the call could be sent through route C. Source Gateway would receive back the same call request it just forwarded on to the First Transmitting Gateway 462. Depending on the intelligence of the Source Gateway, the Source Gateway might immediately send a message to the First Transmitting Gateway 462 indicating that route C has already been attempted and that this route failed. Alternatively, Source Gateway might again try to send the call via route C. Again the route would fail. Either way, the call request would ultimately be bounced back to the First Transmitting Gateway 462 with an indication that the call could not be sent through route C.

When the First Transmitting Gateway 462 gets the call request back from the Source Gateway, it would then consult its routing information and determine that the next route to try is route A. If route A is operable, the call could then be setup between the First Transmitting Gateway 462 and the destination gateway 464 via route A. Although this process eventually results in a successful call setup, there is unnecessary call signaling back and forth between the Source Gateway 460 and the First Transmitting Gateway 462.

Moreover, if the First Transmitting Gateway 462 is unable to set up the call through route A, the First Transmitting Gateway 462 would again consult the routing information it received earlier, and the First Transmitting Gateway 462 would send the call to the Second Transmitting Gateway 463 so that the call can be placed onto the Internet using route E. When the Second Transmitting Gateway 463 receives the call request from the First Transmitting Gateway 462, it too would consult the routing controller and learn that the preferred routes are route C, then route A, then route E. With this information, the Second Transmitting Gateway 463 would forward the call request back to the Source Gateway 460 with instructions to place the call through route C, which would fail again. The Source Gateway 460 would then forward the call back to the Second Transmitting Gateway 463. The Second Transmitting Gateway 463 would then try to complete that call using the First Transmitting Gateway 462 and route A. This too would fail. Finally, the Second Transmitting Gateway 463 would send the call out using route E.

Because each of the gateways are using the same routing information, when one or more routes fail, there can be a large amount of unnecessary looping and message traffic between the gateways as the a call request is passed back and forth between the gateways until the call is finally placed through an operative route. In preferred embodiments of the invention, special routing procedures are followed to reduce or eliminate unnecessary looping.

In preferred embodiments of the invention, if the call attempt fails, the call attempt returns to the Source Gateway 460. The Source Gateway 460 can then query the route controller for a second most optimal route. If the second most optimal route is located through First Transmitting Gateway 462, the route controller attaches a second set of header information identifying the new route to the data packets that comprise the call set up request. The new header information identifies the First Transmitting Gateway 462. The Source Gateway 460 then forwards the second call set-up request to the First Transmitting Gateway 462. The First Transmitting Gateway 462 is configured to strip off the portion of the header data which identifies itself. The First Transmitting Gateway 462 then sends the call setup request on to the Destination Gateway 464. If the second call attempt fails, the data packets are returned to the Source Gateway 460 because the header data identifying the First Transmitting Gateway 462 has been removed. It should be noted that any gateway can be the Source Gateway 460 as long as it is associated with the most optimal route. It should also be noted that any transmitting gateway may be configured to automatically strip off a portion of the header that identifies itself.

To be more specific, if the route controller determined that route C is the most optimal route, the translated header information inserted onto the data packets containing the call setup request would include an identification of the Source Gateway 460, because that is where the route is located, plus the destination gateway 464, plus the destination telephone number. The Source Gateway 460 then attempts the call setup by sending the data packets to the Destination Gateway 464. If the call attempt is successful, the call connection is completed. However, if the call attempt fails, for any reason, it is returned to the Source Gateway 460.

The gatekeeper then queries the route controller for a second most optimal route. For example, in FIG. 12, the second most optimal route may be route A, which is located through the First Transmitting Gateway 462. The Source Gateway 460 would then insert new header information, consisting of the identification of the First Transmitting Gateway 462 in front of the existing header information. The Source Gateway 460 then forwards the call set-up request, with the new header information, to the First Transmitting Gateway 462. The First Transmitting Gateway 462 reads the header information and discovers that the first part of the header information is its own address. The First Transmitting Gateway 462 will then strip off its own identification portion of the header. The First Transmitting Gateway 462 then attempts a call setup to the destination gateway 464. If the second call attempt fails, the destination gateway 464 returns the call attempt to the Source Gateway 460, because the remaining portion of the header only identifies the Source Gateway 460. Thus, rather than bouncing the call attempt back to the First Transmitting Gateway 462, the failed call attempt would simply return to the Source Gateway 460, which tracks route failure and remaining optimal route information. This method can eliminate or reduce unnecessary looping.

In a second embodiment, each of the gateways will know which routes are associated with each gateway. Alternatively, this information may be provided by the routing controller as needed. This means that the First Transmitting Gateway 462 would know that the Source Gateway 460 uses routes C and D, and that the Second Transmitting Gateway 463 uses routes E and F. The gateways can then use this information to reduce or eliminate unnecessary looping.

For instance, using the same example as described above, when a call request comes in to place a call to destination telephone 145, the Source Gateway 460 would first try to send the call via route C. When that route fails, the Source Gateway 460 would send the call request to the First Transmitting Gateway 462 so that the First Transmitting Gateway 462 could send the call via route A. In the prior art system, the First Transmitting Gateway 462 would have bounced the call request back to the Source Gateway 460 because the First Transmitting Gateway 462 would believe that route C is the best way to route that call. But in a system embodying the invention, the First Transmitting Gateway 462 would know that the Source Gateway 460 uses route C. With this knowledge, and knowing that the call request came from the Source Gateway 460, the First Transmitting Gateway 462 would conclude that the Source Gateway 460 must have already tried to use route C, and that route C must have failed. Thus, rather than bouncing the call request back to the Source Gateway 460, the First Transmitting Gateway 462 would simply try the next best route, which would be route A. Similar logic can be used at each of the other gateways to eliminate unnecessary looping.

In another preferred embodiment, special addressing information can be included in the messages passing back and forth between the gateways. For instance, and again with reference to the same example described above, assume that the Source Gateway 460 first gets a call request to complete a call to destination telephone 145. The Source Gateway 460 would try to send the call via route C, and route C would fail. At this point, the Source Gateway 460 would know that the next best route is route A. In this embodiment, before sending the call request on to the First Transmitting Gateway 462, the Source Gateway 460 could encode a special addressing message into the call request. The special addressing message would inform the First Transmitting Gateway 462 that the call request should be sent via a specific route. In the example, the Source Gateway 460 would include addressing codes that indicate that the call request should be sent via route A, since that is the next best route.

When the First Transmitting Gateway 462 receives the call request, it would read the special routing information and immediately know that the call should be sent via route A. If route A is operable, the call will immediately be sent out using route A. If route A is not available, the First Transmitting Gateway 462 would consult the routing controller and determine that the next route to try is route E. The First Transmitting Gateway 462 would then send the call request on to the Second Transmitting Gateway 463 with special addressing information that tells the Second Transmitting Gateway 463 to immediately try to place the call using route E. In this manner, unnecessary looping can be eliminated.

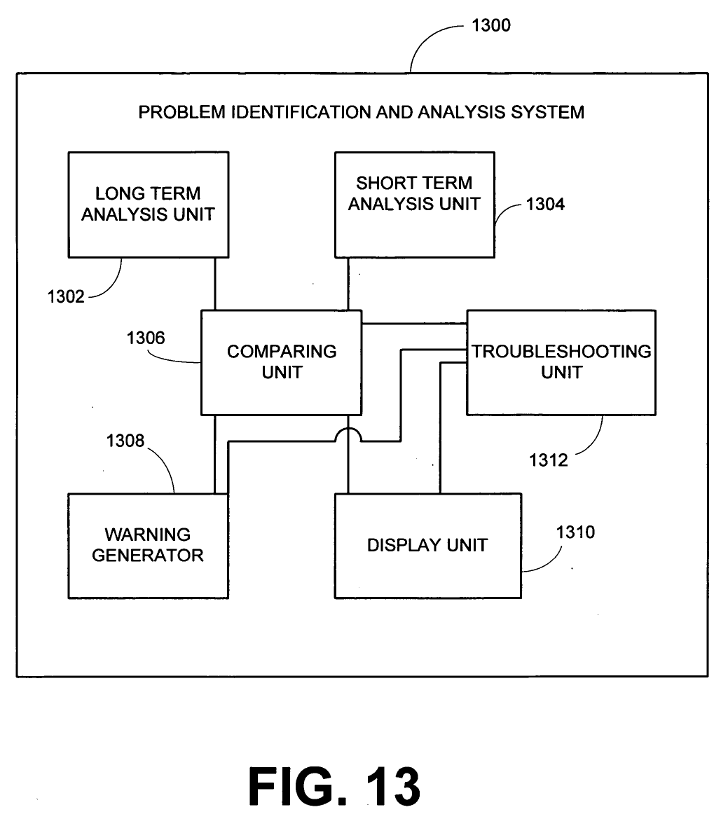

FIG. 13 is a block diagram showing the major components of a system for identifying and analyzing problems that may occur within a system for sending telephone calls over the Internet. The problem identification and analysis system 1300 shown in the FIG. 13 would typically be embodied in software which would run continuously to perform the monitoring and analysis functions.

This system would function to record various call information over relatively long periods of time. This information would then be used to calculate long term averages for the call information. The basic call data might also be combined in various ways to calculate long term averages of call metrics. The system would then record and calculate short term averages of the same call information and call metrics. The system would compare the short term averages to the long term averages to determine if the short term averages deviate from the long term averages by any significant amount. If so, the system will assume there is a problem which is causing the short term averages to deviate in this significant way.

Once a potential problem has been identified, the system could provide a trouble report to system monitoring personnel so that further investigations and corrective action could be undertaken. The system might also be configured to identify specific system assets that could be causing the short term averages to deviate in a significant way. In addition, the system might be configured to automatically make certain changes in response to identified problems so that the system performance is enhanced. For instance, if the short term call metrics for a particular destination service provider have significantly deteriorated from the corresponding long term averages, the system might be automatically modified so that no further calls are sent to that destination service provider.

The system includes a long term analysis unit 1302 which would be configured to at least calculate the long term averages of call information for particular “routes” or destinations. The long term information could be collected for a particular destination, which could mean a particular country, a particular city, or even a sub-portion of a particular city. Alternatively, the long term call information could be collected for all calls placed through a particular destination service provider. The long term averages might also be related to specific routes or specific paths through the Internet. Thus, a single long term average would usually be associated with a specific source, route, location, and/or destination carrier. Long term call information could also be collected for other discrete groupings of calls, as will be apparent to those skilled in the art.

As explained above, this call information would be collected over relatively long periods of time. In this instance, a “long time period” could be hours, days, weeks, months or years. The amount of time required to collect reliable long term information will vary because the number of calls placed within a monitored group will vary. For instance, if the long term call information is being collected on a location-by-location basis, one location such as London, England might receive thousands of calls each hour, whereas a remote location, like a small city in France might only receive a few calls each hour. A “long time period” for London could be two hours, whereas a “long time period” for the small town in France might be two days. The important point, is that one wants to collect enough information over the “long time period” to get a feel for what the average call information should be.

The call information could be collected and stored by the long term analysis unit, or this information could be accessed from other portions of the system which are described above. For instance, this information might be accessed from a traffic database or a traffic analysis engine.

The long term averages that are calculated would have to be recalculated from time to time. And the frequency with which the long term averages are recalculated might depend on the length of the long term average. For instance, if a long term average is for a month's worth of data, it might be appropriate to recalculate the long term average once a day, or once a week. On the other hand, if the long term average represents a year's worth of data, the long term average might only be recalculated on a monthly basis.

The type of call information that is analyzed could include all sorts of call metrics. The call information could include a number of call attempts, a number of completed calls, an average call duration of each call, a total duration of each call, a total duration of all the calls, a number of declined calls, a number of looped calls which have occurred over the specific time period in question, or any other call metric that can be recorded or calculated. This information would then be used to calculate long term averages for specific sources, routes, paths, location and/or destination carriers.

As noted above, the call information could be averages of raw recorded data, or the average may be for a calculated call metric. For instance, the long term average may pertain to ASR, which is the number of completed calls/number of call attempts made, ACD, which is the total duration of all completed calls/total number of completed calls, or any other relevant call metric. Of course, many other call metrics might also be calculated and averaged.

The long term average, whether the average is an actual measured value, or a calculated metric, can vary greatly from one grouping of calls to the next. For instance, the long term ASR for one destination might be 0.80, and for a different destination it might be 0.40. In each case, the long term average would provide a measure of what one would expect to see when the system is functioning correctly. The fact that the numbers are completely different is one reason why the measured values cannot be compared to some predetermined optimum value. The fact that the long term averages can vary greatly from one destination to next is the reason why short term averages must be compared to long term averages to determine that a problem exists.

The system shown in FIG. 13 also includes a short term analysis unit 1304. The short term analysis unit 1304 calculates the same kind of averages of raw call data or calculated call metrics as the long term analysis unit 1302, but for much shorter periods of time.

The long term and short term averages are then provided to a comparison unit 1306. The comparison unit compares the short term averages to the long term averages and notes any discrepancies. The discrepancies could be measured in many different ways, in part depending on how the averages are calculated, and what they represent. The differences could be reported as percentage differences, or as simple numerical differences. Also, the comparison unit could be configured to report all discrepancies, or only those that rise above a certain level.

In some embodiments of the invention the comparison unit might only compare a single short term average to the currently existing long term average, and then report any significant discrepancies. In other embodiments of the invention, the comparison unit might note when a short term average deviates from the corresponding long term average by more than a predetermined amount. The comparison unit could then be configured to wait until additional short term averages are calculated and compared to the long term averages to see if the same problem persists for more than one short time period. The comparison unit could then report the discrepancy only after the problem has persisted for a predetermined length of time.

In addition, we know that some types of call information naturally varies depending on the time of day, the day of the week, or based on proximity to holidays. For this reason, it might by appropriate to compare a short term average for a call metric to a long term average for only the corresponding time period or the corresponding day of the week/month.

For instance, we might know that a call metric for calls placed to a certain location tend to peak on Sundays, and that the same call metric has a relatively low value during all other days of the week. In this instance, it would not make sense to compare a short term average of this call metric on Sunday with the long term average for all days of the week. Instead, it would make more sense to compare the short term Sunday values with an average of only Sunday values over the long term. Likewise, it would only make sense to compare a short term average of this metric on a weekday to a long term average of only the weekdays.

Thus, the comparison unit 1306 might be configured to carefully compare short term averages only to relevant corresponding long term averages of the same call metrics. The configuration of the comparisons must be done with careful knowledge of what relates to what. Otherwise, a noted discrepancy could be meaningless. In other words, even if a discrepancy between a long term and a short term average is large, it might simply be reflective of normal fluctuations in call traffic, rather than an actual problem with the system.

The comparison unit 1306 would output information to a warning generator 1308, to a display unit 1310, and to a troubleshooting unit 1312. The warning generator would be configured to provide some sort of output to system personnel responsible for monitoring the network. This output could be in the form of an audible tone, an e-mail reporting a potential problem, or in some other fashion. In addition, the warning generator 1308 might be configured to provide a warning each time that it receives input from the comparison unit 1306, or only when a discrepancy noted by the comparison unit 1306 rises above a threshold value. So, for instance, the comparison unit might be configured to report all discrepancies, and the warning generator might be configured to examine the discrepancies to determine which ones are significant enough to warrant further attention. Alternatively, the comparison unit might be configured to report only significant discrepancies, and the warning generator might be configured to provide a warning each time it receives input from the comparison unit.

The display unit 1310 is configured to provide system personnel with a way of easily reviewing all the information calculated by the long term analysis unit 1302, the short term analysis unit 1304 and the comparison unit 1306. The display unit could be configured to present this information in a tabulated or graphical format, depending on how the information is most easily interpreted and viewed. One preferred way to display the data is in a tree format. Also, because many of the calculated long and short term averages relate to specific sources, paths, routes and destinations, the display unit 1310 could be configured to allow a user to easily collect and view multiple call metrics that relate to a certain source, path, route, destination and/or destination carrier. This could help the user to draw conclusions about the likely sources of a potential problem.

The troubleshooting unit 1312 is configured to attempt to determine which system assets might be defective. The troubleshooting unit 1312 would receive information from the comparison unit 1306 relating to the discrepancies noted between the long term and the short term call metric averages. The troubleshooting unit 1312 would then use this information to attempt to determine what might be causing the discrepancy. In some instances, this might involve accessing and analyzing additional call data from other parts of the system.

For instance, if the troubleshooting unit notes that the short term average of one or more call metrics for calls placed to a certain country are deviating in a significant fashion from the long term average, the troubleshooting unit might proactively try to determine where the problem lies. At this point, the trouble shooting unit might find that two different destination carriers complete calls within that country. The troubleshooting unit could then separately recalculate the short term averages for calls placed through each destination carrier, and the two separate short term averages could be compared to the long term average. This might well reveal that one destination carrier is well outside the average, and that the other destination carrier is operating within normal limits. This would allow the troubleshooting unit to determine and report that the problem likely lies with one of the two destination carriers. Of course, many other actions could also be taken by the troubleshooting unit to try to determine where a potential problem lies.

In addition, the system might be configured to proactively take action to correct a problem that has been noted by the troubleshooting unit 1312. For instance, in the example given above, the troubleshooting unit determined that one of two destination service providers in a particular country is having trouble completing calls. The system might use this information to decide to stop routing calls to the destination service provider having problems. This could involve communicating with the routing engine to instruct the routing engine to stop sending calls to that destination service provider. This would the routing engine to no longer provide routes to the originating gateways that include that destination service provider. This type of automated response to a problem might be done at the same time a message is sent to system monitoring personnel to advise them of the action taken.

The system might also be configured such that automated actions are only taken when the short term averages for a particular route or destination cross a threshold level. As explained above, it is virtually impossible to set a threshold for a particular call value or call metric which will apply for all routes and destinations because of the great variability of the averages from route to route or from destination to destination. However, the system monitoring personnel could review a long term average for a particular route or destination, and then set a threshold value which, if crossed, is likely to indicate that a problem has arisen. Alternatively, the system might be configured so that if a short term average deviates from a long term average for a particular route or destination by more than a set percentage of the long term average, then the change indicates that a problem has arisen. In each case, the system might be configured to take immediate action once the threshold value has been crossed.

While the above is a general description about how the individual major elements of the problem identification and analysis system operate, those of ordinary skill in the art will appreciate that many different variations and permutations are possible. For instance, a great many different types of call data and call metrics could be averaged on both a long term and a short term basis to make these comparisons. The length of a “long term” and the length of a “short term” could vary depending on a multitude of different factors. Likewise, the way that the comparisons are made and that potential trouble spots are identified could vary for many, many different reasons. Because of all these different potential variations at each level of the system, it is virtually impossible to provide an explanation of each different possible permutation. However, those of skill in the art will appreciate how to configure such a system to produce meaningful results.

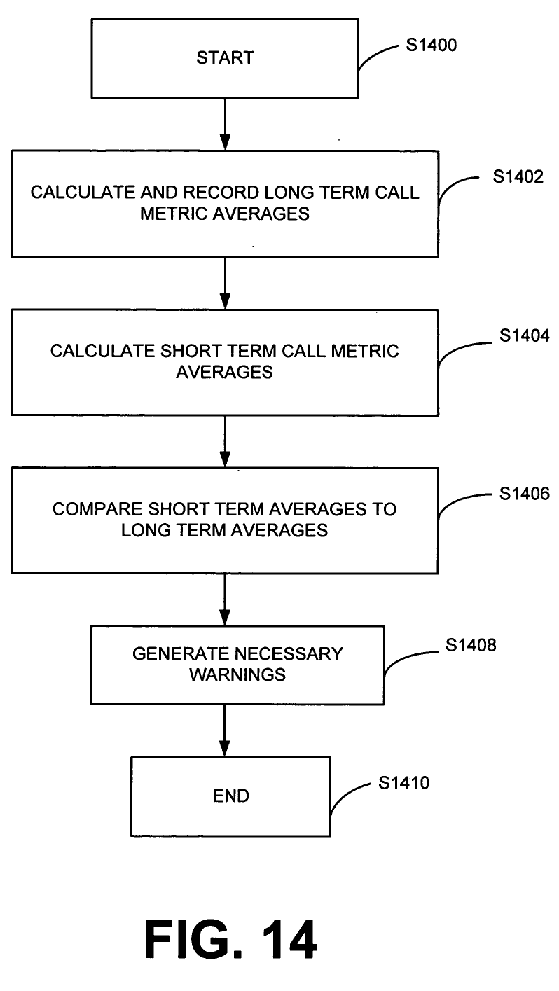

FIG. 14 is a flow diagram of one method embodying the invention for monitoring network quality and generating trouble reports. The operation begins in step S1400 and proceeds to step S1402 where long term averages for call data and call metrics are calculated and recorded. The long term averages could be calculated only periodically, whereas the short term averages would typically be calculated in “real-time.” As mentioned above, these long term averages could relate to specific sources of calls, to specific paths and routes, to particular destinations, to specific destination carriers, or to some other coherent way of classifying a set of calls. The method would proceed to step S1404, where corresponding short term averages for the same call data or call metrics are calculated. Then, in step S1406, the short term averages would be compared to the long term averages. In this comparison step, in most instances, a long term average that was previously calculated would be retrieved and compared to a short term average that is calculated just before the comparison step is performed. Thereafter, in step S1408, warnings are generated if the comparisons performed in step S1406 indicate that a potential problem exists. The method would then end in step S1410.

This method could also include a step of recording when a particular type of trouble occurs. If this is done, and the data is tracked over a period of time, the general trend for particular problems could be noted. Then, if a particular problem tends to re-occur on a frequent basis, some type of corrective action could be taken. For instance, if the system notes that a particular destination service provider has been failing to complete a significant number of call on a re-occurring basis, the system could alert system personnel to take steps to remove the destination service provider from the list of available providers. Alternatively, the system could be configured to take this action automatically if the number of trouble reports per unit of time exceeds a predetermined threshold.

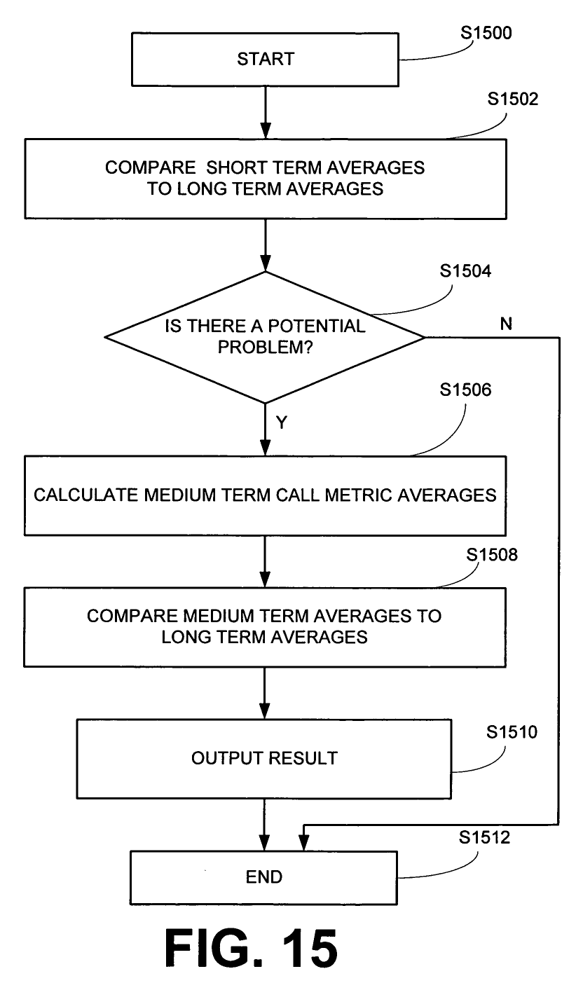

FIG. 15 is a flow diagram illustrating a method of comparing long term averages to shorter term averages to determine if a potential problem exists. The steps of this method would generally correspond to step S1406 shown in the method of FIG. 14.

In this method, after starting in step S1500, the method would proceed to step S1502, where short term averages are compared to long term averages. The results of these comparisons would be evaluated in step S1504 to determine if significant discrepancies exist between the short term and long term averages. If no significant discrepancies exist, it will be determined that no potential problems exist and the method will proceed to step S1512, where the method will end. If a significant discrepancy between the short and long term averages does exist, the method will determine that a potential problem does exist, and the method will proceed to step S1506.

In step S1506, the method will calculate medium term call data or call metric averages. These medium term averages will be for a longer period of time than the short term averages. The point of taking medium term averages is to see is a noted potential problem is just an isolated random occurrence, or evidence of a real problem. The assumption is that if a real problem exists, the discrepancy noted for a short term average will still occur in the medium term average.

In step S1508, the medium term average for the call data or call metrics will be compared to the long term averages. Then, in step S1510, the results will be output. The results could be the actual discrepancy noted between the medium term average and the long term average, or just a further indication that a problem exists or does not exist. The method would then end in step S1512.

A method shown in FIG. 15 provides an automated way of verifying that a potential problem actually exists, and that the data is not simply reflective of an isolated variation away from the long term averages. As mentioned above, there might be other ways of checking to see if a discrepancy between a short term average and a long term average is truly reflective of a problem.

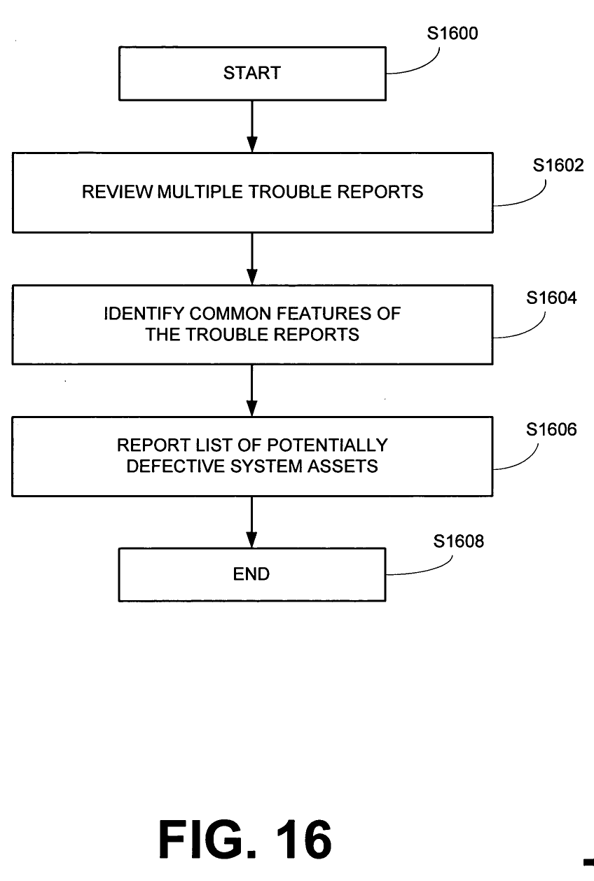

FIG. 16 illustrates a method embodying the invention for troubleshooting a system to determine which system assets may be experiencing problems. The method starts at step S1600, and proceeds to step S1602, where multiple trouble reports are reviewed and analyzed. This step is necessary to determine which system assets could be involved in creating a problem noted in a trouble report. Next, in step S1604, the method would attempt to identify the common features between different trouble reports. In other words, the method would attempt to draw correlations between different trouble reports by identifying common system assets that could be causing the problems noted in different trouble reports. Next, in step S1606, based on the information developed in the preceding steps the system would output a list of system assets that are potentially defective. The method would then end in step S1608.

As mentioned before, a problem identification and analysis system as shown in FIG. 13, and which performs methods as illustrated in FIGS. 14-16 would typically be embodied in software. Ideally, the system would operate continuously using the call data and call metrics maintained by a Voice Over IP system like the one described earlier in the application. The problem identification and analysis system would periodically recalculate the long term averages based on the information in the system. The short term averages would also be calculated according to a regular schedule, and the short term averages would be compared to the long term averages for purposes of identifying and addressing potential problems.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of identifying potential problems with system assets in a system for routing telephone calls over the Internet, comprising:
calculating at least one long term average for call data relating to telephone calls placed over the Internet by the system;
calculating at least one corresponding short term average for call data relating to telephone calls placed over the Internet by the system;
comparing the at least one long term average to the corresponding at least one short term average; and
generating a warning if the results of the comparing step indicate that there is a significant difference between the at least one long term average and the corresponding at least one short term average.

2. The method of claim 1, wherein the step of calculating at least one long term average comprises calculating the at least one long term average using call data that has been obtained over a time period of between one day and one year.

3. The method of claim 1, wherein the step of calculating at least one short term average comprises calculating the at least one short term average using call data that has been obtained over a time period of between one minute and 24 hours.

4. The method of claim 1, wherein the at least one long term average is a long term average of a member selected from the group consisting of a number of call attempts made, a number of completed calls, an average call duration of each call, a total duration of all calls, a number of declined calls, and a number of looped calls.

5. The method of claim 1, wherein the at least one long term average is a long term average of a member selected from the group consisting of ASR, ACD, and ABR, wherein
ASR=a number of completed calls/a number of call attempts made, wherein ACD=a total duration of all completed calls/a total number of completed calls, and wherein ABR=a number of completed calls/a number of call attempts made+a number of looped calls.

6. The method of claim 1, wherein the at least one long term average comprises a long term average of call data relating to calls made to a selected location.

7. The method of claim 6, wherein the at least one long term average comprises a long term average of call data for calls made to one member selected from group consisting of calls made to a selected country code, calls made to a selected country and city code, calls made to a selected inbound trunk group, and calls completed through a selected destination carrier.

8. The method of claim 1, further comprising the steps of:
calculating at least one corresponding medium term average for call data relating to telephone calls placed over the Internet by the system if the results of the comparing step indicate that there is a significant difference between the at least one long term average and the corresponding at least one short term average; and
comparing the at least one long term average to the corresponding at least one medium term average, and wherein the step of generating a warning only results in a warning being generated if the results of the comparing steps indicate that there is a significant difference between the at least one long term average and both the corresponding at least one short term average and the corresponding at least one medium term average.

9. A method of identifying a potentially defective system asset in a system for routing telephone calls over the Internet, comprising:
reviewing at least one trouble report which indicates a significant discrepancy between a long term call data average and a short term call data average; and
identifying potentially defective system assets that could cause the noted significant discrepancy.

10. The method of claim 9, wherein the reviewing step comprises reviewing multiple trouble reports.

11. The method of claim 10, wherein the identifying step comprises identifying common system assets that could have caused the noted significant discrepancies appearing in at least two of the multiple trouble reports.

12. The method of claim 9, wherein the identifying step comprises identifying at least one member selected from the group consisting of an inbound trunk group, an outbound trunk group, an Internet service provider, a gateway, and a destination carrier.

13. A system for identifying potential problems with system assets in a system for routing telephone calls over the Internet, comprising:
means for calculating at least one long term average for call data relating to telephone calls placed over the Internet by the system;
means for calculating at least one corresponding short term average for call data relating to telephone calls placed over the Internet by the system;
means for comparing the at least one long term average to the corresponding at least one short term average; and
means for generating a warning if the comparing means indicate that there is a significant difference between the at least one long term average and the corresponding at least one short term average.

14. The system of claim 13, further comprising means for identifying potentially defective system assets based on the output of the comparing means.

15. The system of claim 14, wherein the means for identifying potentially defective system assets is also configured to calculate long term and short term averages for call data relating to telephone calls placed over the Internet by the system.

16. A system for identifying potential problems with system assets in a system for routing telephone calls over the Internet, comprising:
a long term analysis unit configured to calculate at least one long term average for call data relating to telephone calls placed over the Internet by the system;
a short term analysis unit configured to calculate at least one corresponding short term average for call data relating to telephone calls placed over the Internet by the system;
a comparison unit configured to compare the at least one long term average to the corresponding at least one short term average; and
a warning generator configured to generate a warning if the comparison unit indicates that there is a significant difference between the at least one long term average and the corresponding at least one short term average.

17. The system of claim 16, further comprising a display unit for generating a display that summarizes the information produced by at least one of the long term analysis unit, the short term analysis unit and the comparison unit.

18. The system of claim 17, wherein the display unit is also capable of summarizing the information produced by the warning generator.

19. The system of claim 16, further comprising a troubleshooting unit that is configured to identify potentially defective system assets based on the information produced by the comparison unit.

20. The system of claim 19, wherein the troubleshooting unit is also configured to calculate long term and short term averages for call data relating to telephone calls placed over the Internet by the system.
